(19) United States
(12) Patent Application Publication
(10) Pub. No.: US 2022/0272122 A1
(43) Pub. Date: Aug. 25, 2022

(54) AUTONOMOUS VEHICLE CONTROL ATTACK DETECTION AND COUNTERMEASURES

(71) Applicant: University of North Dakota, Grand Forks, ND (US)

(72) Inventors: Naima Kaabouch, Grand Forks, ND (US); Mohsen Riahi Manesh, Grand Forks, ND (US)

(21) Appl. No.: 17/183,926

(22) Filed: Feb. 24, 2021

(51) Int. Cl. H04L 29/06; B60W 60/00; G06N 20/00

(52) U.S. Cl. CPC H04L 63/1466; B60W 60/00188; G06N 20/00; H04L 63/1416; B60W 2556/45

(57) ABSTRACT

The present subject matter provides improved solutions for autonomous vehicle malicious control attacks. One technical solution for detecting and mitigating autonomous vehicle malicious control attacks includes receiving a malicious control signal, determining signal characteristics based on the malicious control signal, determining an autonomous vehicle attack based on signal characteristics, determining an attack countermeasure based on the attack determination, and sending a modified autonomous vehicle control signal to an autonomous vehicle based on the attack countermeasure. This solution may further include sending the signal characteristics to an autonomous vehicle attack machine learning (ML) system and receiving ML signal characteristics from the autonomous vehicle attack ML system, where the attack determination is based on the ML signal characteristics. This solution may further include sending the attack determination to the autonomous vehicle attack ML system and receiving the ML attack determination from the autonomous vehicle attack ML system, where the generation of the attack countermeasure is further based on the ML attack determination.

### STATEMENT OF GOVERNMENT SPONSORED SUPPORT

The subject matter herein was developed with Government support under National Science Foundation award No. 2006674, The Government has certain rights to the subject matter herein.

### TECHNICAL FIELD

Embodiments described herein generally relate to autonomous vehicles.

### BACKGROUND

Autonomous vehicles may be used to transport people or goods without requiring full driver or pilot control. Autonomous vehicles may include terrestrial autonomous vehicles (e.g., robotaxis, self-driving cars) and unmanned aerial vehicles (UAVs). Fully autonomous vehicles may receive a destination and navigate autonomously and safely to the indicated destination while avoiding pedestrians or other obstacles. Partially autonomous vehicles may receive control inputs from a vehicle operator driver, pilot) and may modify vehicle controls (e.g., steering) to maneuver the vehicle based on the control inputs. In an example, a UAV controller may send control signals to the UAV, where the control signals may provide flight controls (e.g., altitude adjustment), flight operation instructions (e.g., obstacle avoidance), flight route instructions (e.g., a destination), or other control signals. A malicious actor may attempt to control an autonomous vehicle or block the primary control signals, using attacks such as signal jamming, message injection, or other control signal attacks. What is needed is an improved solution for addressing attacks targeting autonomous vehicle control.

### BRIEF DESCRIPTION OF THE DRAWINGS

FIG. 1 is a block diagram of an autonomous vehicle control attack defense system, in accordance with at least one embodiment.

FIG. 2 is a block diagram of signal characteristics calculation subsystem details, in accordance with at least one embodiment.

FIG. 3 is a signal eye diagram, in accordance with at least one embodiment.

FIG. 4 is a graph of an error vector magnitude (EVM) determination, in accordance with at least one embodiment

FIG. 5 is a block diagram of countermeasure determination subsystem details, in accordance with at least one embodiment.

FIG. 6 is a block diagram of a beamforming structure, in accordance with at least one embodiment.

FIG. 7 is a diagram of an autonomous vehicle interference attack defense method, in accordance with at least one embodiment.

FIG. 8 is a block diagram of an example neural network training system for autonomous vehicle control attack detection, according to an embodiment.

FIG. 9 is a block diagram illustrating an autonomous vehicle control attack detection and mitigation system in an example form of an electronic device, according to an example embodiment.

### DESCRIPTION OF EMBODIMENTS

The present subject matter provides various technical solutions to technical problems facing autonomous vehicle control attacks (e.g., malicious control signals, jamming, etc.). One technical solution for detecting and mitigating autonomous vehicle control attacks includes receiving a malicious control signal, determining signal characteristics based on the malicious control signal, determining an autonomous vehicle attack based on signal characteristics, determining an attack countermeasure based on the attack determination, and sending a modified autonomous vehicle control signal to an autonomous vehicle based on the attack countermeasure. This solution may further include sending the signal characteristics to an autonomous vehicle attack machine learning (ML) system and receiving ML signal characteristics from the autonomous vehicle attack ML system, where the attack determination is based on the ML signal characteristics. This solution may further include sending the attack determination to the autonomous vehicle attack ML system and receiving the ML attack determination from the autonomous vehicle attack ML system, where the generation of the attack countermeasure is further based on the ML attack determination.

The technical solutions described herein provide various advantages. These solutions do not require changes to the wireless infrastructure or protocols that are used to communicate between the autonomous vehicle and the autonomous vehicle controller, and can therefore be implemented on the wireless radio systems. This provides improved autonomous vehicle attack mitigation without requiring the increased complexity, cost, or device size that would be associated with a solution that required changes to wireless infrastructure or protocols. These solutions further benefit from a dual-countermeasure method, including a solution in which the malicious control signal is blocked and the radio switches to a new available frequency according to the channel occupancy. These solutions also include the use of compressive spectrum sensing, which is able to provide a rapid response to identify spectrum holes quickly and recover the lost communication due to attack.

These solutions further provide improved performance using machine learning algorithms. In an example, the detection and mitigation system may be trained in different environments, which provides improved performance in addressing problems caused by signal propagation, such as reflections and blockages. This reduces incorrect attack determinations (e.g., false alarms, miss detections), which further improves accuracy. The machine learning algorithms also provide an improvement in the speed and accuracy in attack detection and mitigation response time.

The following description and the drawings sufficiently illustrate specific embodiments to enable those skilled in the art to understand the specific embodiment. Other embodiments may incorporate structural, logical, electrical, process, and other changes. Portions and features of various embodiments may be included in, or substituted for, those of other embodiments. Embodiments set forth in the claims encompass all available equivalents of those claims.

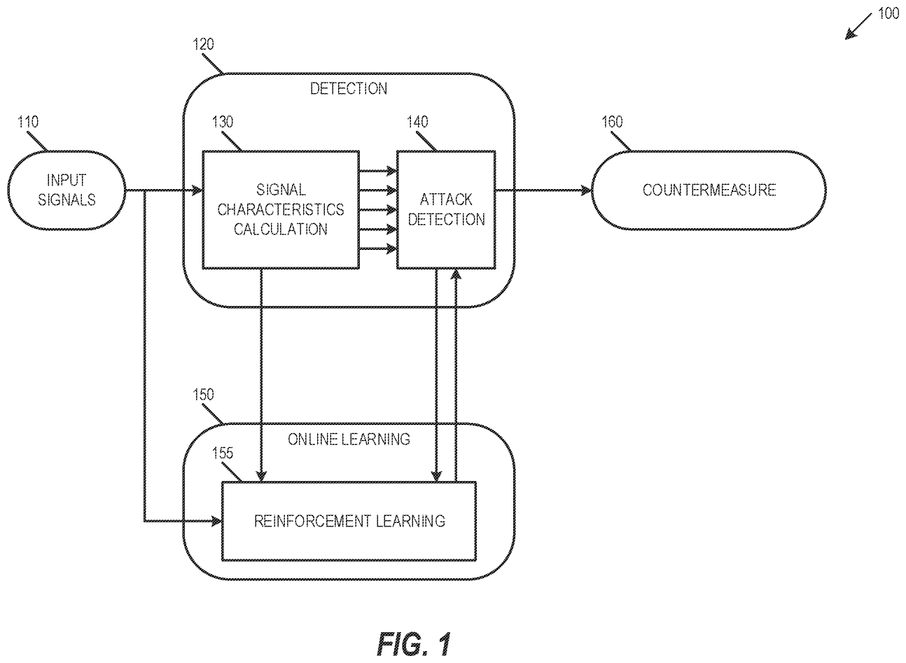

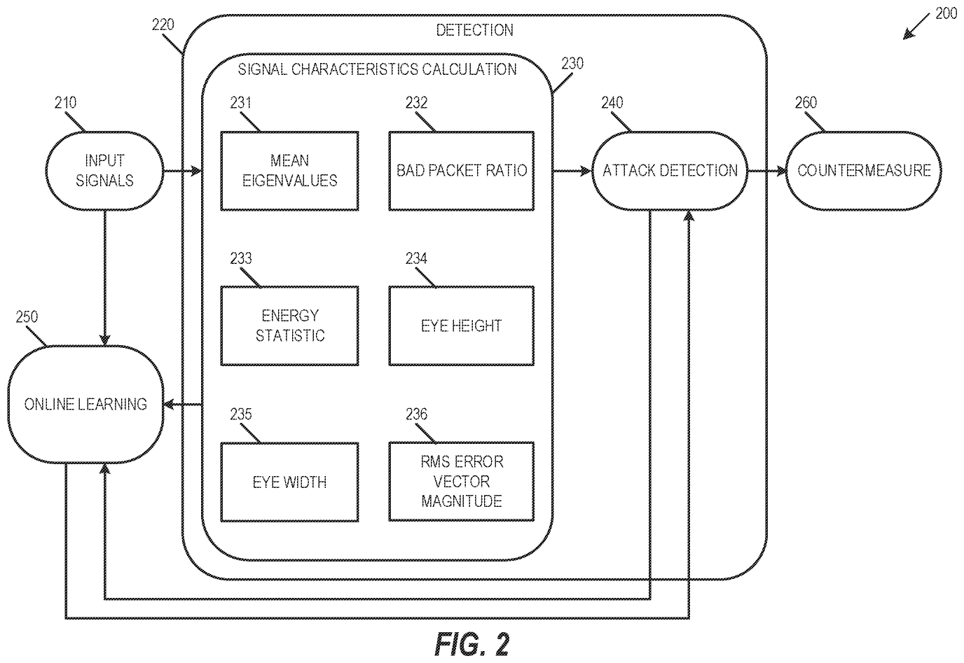

FIG. 1 is a block diagram of an autonomous vehicle control attack defense system 100, in accordance with at least one embodiment. As shown in FIG. 1, system 100 includes multiple subsystems, such as a detection subsystem 120. Detection subsystem 120 receives input signals 110, such as autonomous vehicle control signals or a malicious vehicle control attack (e.g., jamming attack) signal. Detection subsystem includes a signal characteristics calculation subsystem 130 to identify one or more signal characteristics (e.g., extract features) from the input signals 110, such as detailed below with respect to FIG. 2.

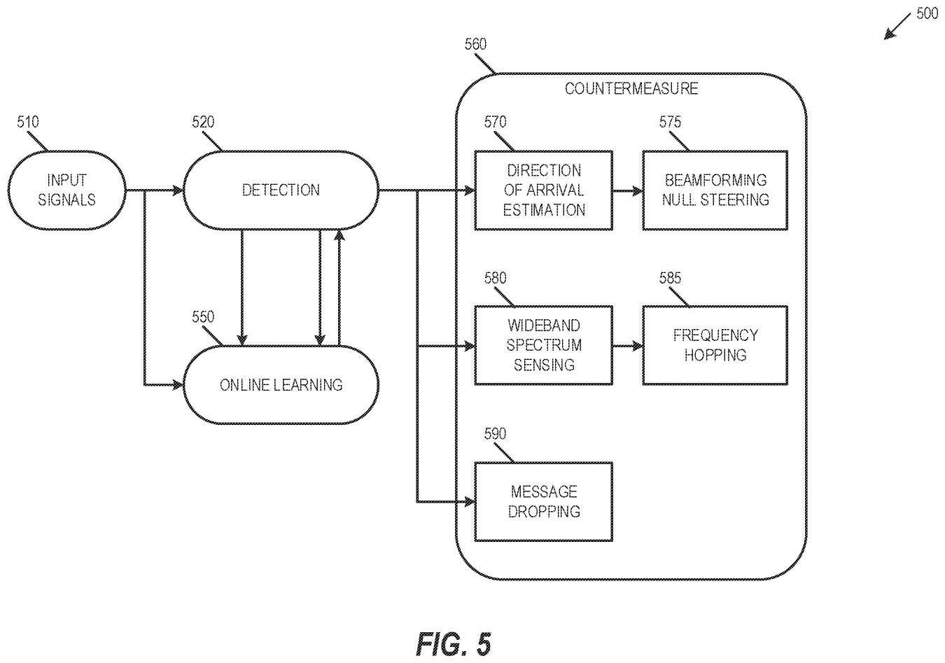

The signal characteristics identified by the signal characteristics calculation subsystem 130 may be fed into the attack detection subsystem 140. The attack detection subsystem 140 includes a detection algorithm for control attacks. In an example, this algorithm includes a supervised machine learning algorithm. When the algorithm is trained it may be used to receive extracted features from subsystem 130 and classify the signals. In an example, the attack detection subsystem 140 generates an extracted signal feature classification, which may be used to indicate the input signals 110 are attack signals or legitimate autonomous vehicle control signals. The attack detection subsystem 140 may provide this extracted signal feature classification and the input signal 110 as an output to a countermeasure determination, such as detailed below with respect to FIG. 5.

The input signals 110 and the signal characteristics identified by the signal characteristics calculation subsystem 130 may be fed into an online learning subsystem 150. The online learning subsystem 150 may be used to train or update the algorithm used in the attack detection subsystem 140. The signal characteristics calculation subsystem 130 may extract features from the input signals 110, however this determination may be improved using the online learning subsystem 150. In an example, the input signals 110 are provided to a reinforcement learning (RL) subsystem 155, which may use signal characteristics generated by the signal characteristics calculation subsystem 130 to update the learning model (e.g., reward or punish the RL process). Based on features extracted from the signal characteristics calculation subsystem 130, the input signals 110 may be classified (e.g., jamming, non jamming, which may be used to improve the attack detection subsystem 140.

FIG. 2 is a block diagram of signal characteristics calculation subsystem details 200, in accordance with at least one embodiment. As shown in FIG. 2, the signal characteristics calculation subsystem 230 within the detection subsystem 220 is designed to extract features and other information from the received signals. This extracted information may be provided to the online learning subsystem 250 or to the attack detection subsystem 240. In an example, this extracted information may be classified into two broad categories, including (a) information that is taken from the content of the message, and including (b) information that is extracted from the physical signal itself. In an example, jamming and non-jamming ranges for features are researched and found experimentally from non-malicious control signals. The signal characteristics calculation subsystem 230 extracts characteristics of the input signals 210 that provide improved reliability of distinguishing between malicious and non-malicious autonomous vehicle control signals. These characteristics may include mean eigenvalues 231, a bad packet ratio 232, an energy statistic 233, an eye height 234, an eye width 235, and an RMS error vector magnitude (EVM) 236, as described below.

The mean eigenvalues 231 may be generated based on the covariance matrix of the input signals 210. The signal characteristics calculation subsystem 230 may use these mean eigenvalues 231 to identify a malicious control signal, such as based on the mean eigenvalues 231 of a received malicious control signal covariance matrix indicating larger values than that of a non-malicious control signal. To calculate the mean eigenvalues 231, N_{L} received signal samples, x[n], may be obtained and stored in an array as:

[x[0], x[1], x[2], . . . , x[Nₜ−1]]

A value known as the smoothing factor may be chosen and denoted as L. An L×N_{L} dimension matrix may be formed, where each row of the matrix is comprised of L time-shifted versions of the received signal samples x[n], as shown by:

$$X = ( \begin{matrix}{x}_{1 , 1} & ⋯ & {x}_{1 , N} \\ ⋮ & ⋱ & ⋮ \\ {x}_{L , 1} & ⋯ & {x}_{L , N}\end{matrix} )$$

where x_{i,j} is the received signal vector sample, L is the number of Eigenvalues and Nₜ is the length of the received signal vector. The sample covariance matrix may be computed as the product of the matrix, X, and its Hermitian transpose, X^{H}, averaged over Nₜ samples, which is given by:

$${\hat{R}}_{x} = \frac{1}{{N}_{t}} {XX}^{H}$$

This calculated sample covariance matrix may be used to identify a malicious control signal, such as by determining that the calculated sample covariance matrix values are larger than that of a non-malicious control signal.

The bad packet ratio 232 may be generated based on the input signals 210. In an example, the autonomous vehicle signal protocol may determine a cyclic redundancy check (CRC) of a received autonomous vehicle signal message (e.g., autonomous vehicle signal packet). If the CRC fails, that autonomous vehicle signal message may be dropped. Jamming and modification attacks may increase the number of received erroneous bits, which may result in an increase in the number of bad packets that are dropped. In an example, the bad packet ratio (BPR) 232 for pulse position modulation may be calculated as:

BPR_{PPM}=(1−BER)^{m/l}^{ₛ}

where m is the number of bits per packet, lₛ is the number of bits per symbol (e.g., one bit per symbol per the autonomous vehicle signal protocol), and BER is the bit error rate. In binary pulse position modulation, BER for a non-coherent receiver such as an autonomous vehicle signal receiver may be calculated theoretically as:

$$BER = \frac{1}{2} exp ( - \frac{{E}_{b}}{2 {N}_{0}} )$$

where E_{b}/N₀ is energy per bit to noise power spectral density ratio. There is a strong relationship between BER and signal to noise ratio (SNR), as follows:

$$SNR = \frac{S}{N} = \frac{{E}_{b} {R}_{b}}{{N}_{0} B}$$

where S is the signal power, N is the noise power, R_{b} is the bit rate, and B is the bandwidth.

The energy statistic 233 may be generated based on the input signals 210. This energy statistic 233 is based on the energy of the received input signal 210, where the energy of the input signal 210 includes energy from transmitted signal components combined with the energy from noise components. As a result, when a jamming signal or other malicious control signal is received, the malicious control signal energy may be much higher than a non-malicious control signal energy received from a legitimate node located at the same distance to the receiver as the jammer. The energy statistic 233 is based on the received signal, x(t), which is in the form of: x(t)=s(t)+w(t) where w(t) is the noise component and s(t) represents the transmitted signal. This energy statistic, E, of the received signal, may then be calculated as follows:

E=∫_{-∞}^{+∞}|x(t)|²dt

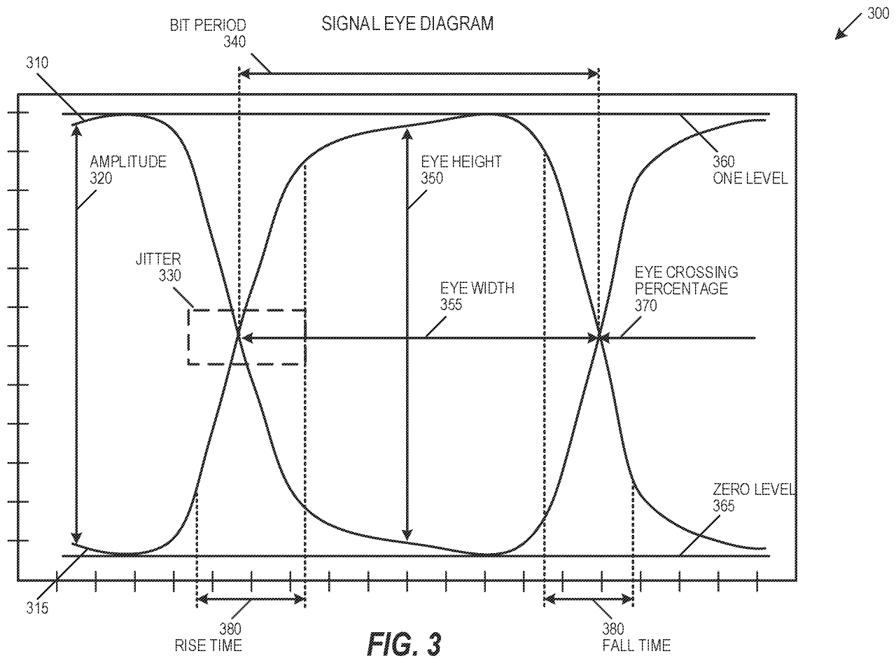

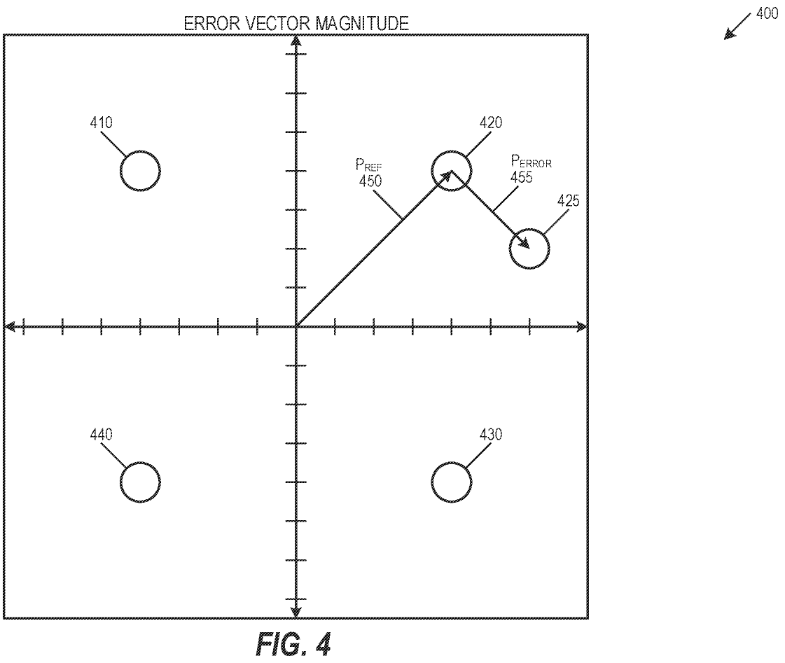

The signal characteristics calculation subsystem 230 may also include an eye height 234 and an eye width 235 discussed with respect to FIG. 3, and may also include an RMS error vector magnitude 236 discussed with respect to FIG. 4.

FIG. 3 is a signal eye diagram 300, in accordance with at least one embodiment. Signal eye diagram 300 may be used to characterize a signal source or transmitter. Signal eye diagram 300 may be used to extract eye opening measurements, such as eye height 350 and eye width 355. These eye opening measurements may be used to measure the eye opening quality, and may be used to detect whether signals are jammed.

As shown in FIG. 3, eye height 350 includes a measure of the vertical opening of signal eye diagram 300. In an example, an ideal eye opening measurement may be equal to the eye amplitude measurement 320. Ideal eye opening measurements are not always realized in practice, such as when signal noise on the signal eye diagram 300 that causes the eye to close. As a result, the eye height measurement 350 may be used to determine the extent of eye closure due to noise. The signal to noise ratio of the high speed data signal may also directly indicated by the amount of eye closure. The eve width 355 is a measure of the horizontal opening of an eye diagram. The eye width 355 may be calculated by measuring the difference between the statistical mean of the crossing points of the eye.

FIG. 4 is a graph of an error vector magnitude (EVM) determination 400, in accordance with at least one embodiment. The EVM may be used to quantify performance of digital radio transmitter or receiver. As shown in FIG. 4, the performance may be quantified by measuring deviations from ideal constellation points 410, 420, 430, 440, such as deviated point 425. This and other deviations may be caused by malicious control signals, phase noise, carrier leakage, and other deviation causes.

As shown in FIG. 4, the EVM is based on P_{ref} 450 and Pₑᵣᵣₒᵣ 455. The EVM may be calculated as follows:

$$EVM ( dB ) = 10 {log}_{10} ( \frac{{P}_{error}}{{P}_{ref}} )$$

To take into account all the data symbols in a transmitted packet of data, root mean squared EVM (EVM_{RMS}) may be measured and used as a signal feature to detect malicious control signals. The EVM_{RMS} may be calculated as follows:

$${EVM}_{RMS} = \sqrt{\frac{\frac{1}{N} {Σ}_{i = 1}^{N} {e}_{k}}{\frac{1}{N} {Σ}_{i = 1}^{N} ( {I}_{k}^{2} + {Q}_{k}^{2} )}} where \\ {e}_{k} = {( {I}_{k} - {\overline{I}}_{k} )}^{2} + {( {Q}_{k} - {\overline{Q}}_{k} )}^{2}$$

iₖ=In-phase measurement of the kth symbol
Qₖ=Quadrature-phase measurement of the kth symbol
N=Input vector length
Iₖ and Qₖ represent transmitted (reference) values
Ī_{K} and Q̅ₖ represent received (measured) values
   This EVM determination 400 may be used in attack detection and determination and deployment of countermeasures. Referring back to FIG. 2, the EVM determination 236 may be used alone or combined with other signal characteristics generated by the signal characteristics calculation subsystem 230 and provided to the attack detection subsystem 240. The attack detection subsystem 240 may provide the input signal 210 and a determination of an extracted signal feature classification (e.g., malicious or non-malicious) as an output to the countermeasure determination subsystem 260, such as shown in FIG. 5.

FIG. 5 is a block diagram of countermeasure determination subsystem details 500, in accordance with at least one embodiment. As shown in FIG. 5, the countermeasure determination subsystem 560 receives input from the detection subsystem 520, such as the input signal 510 and a determination of an extracted signal feature classification. These inputs may be provided to a direction of arrival (DOA) estimation subsystem 570. In estimating the DOA, the received signal model may be composed of a number of signals M impinging at the antenna array, each of the signals deteriorated by white Gaussian noise. Such a received signal may be in the form of:

$$X = {\sum }_{m = 1}^{M} {α}_{m} s ( {∅}_{m} ) + n$$

where s(Øₘ) represents the steering vector of the signal whose direction, Øₘ, is to be estimated. The amplitude is denoted with αₘ. The noise vector n is zero-mean Gaussian. The correlation function may be used to estimate Øₘ, m=1, . . . , M based on an estimation of incident angles. The correlation function plots P_{corr}(Ø) as follows:

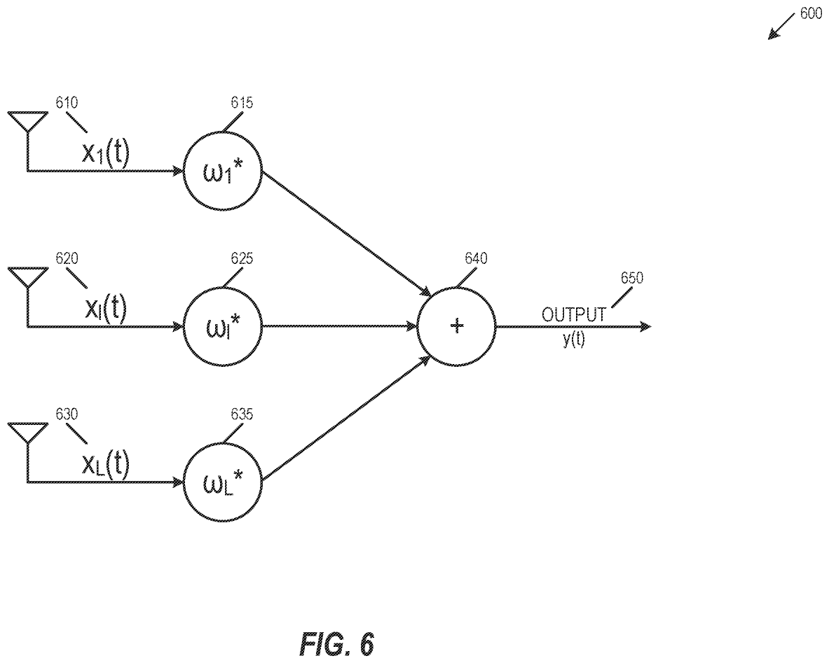

P_{corr}(Ø)=s^{H}(Ø)x

where s^{H}(Ø)s(Øₘ) has a maximum at Ø=Øₘ. The M largest peaks of the correlation plots therefore correspond to the estimated direction of arrivals. In the case of linear, equally-spaced array, the steering vector s(Ø) is equivalent to Fourier coefficients, where the correlation function is equivalent of a Discrete Fourier Transform of the received signal x. The estimated DOA 570 may be used in beamforming and null steering 575, shown in FIG. 6.

FIG. 6 is a block diagram of a beamforming structure 600, in accordance with at least one embodiment. In an example, a beam former may be based on a delay-and-sum beamforming structure with weights of equal magnitudes. As shown in FIG. 6, one or more received signals x(t) 610 620 630 may be weighted with corresponding weights ω 615 625 635, and summed 640 to generate output y(t) 650. The phases may be selected to steer the array in a particular direction (Ø₀, θ₀) (e.g., look direction). Considering the s₀ to be the steering vector in the look direction, the array weights are given by:

$${ω}_{c} = \frac{1}{L} {s}_{0} where \\ {s}_{i} = {[ exp ( j 2 {πf}_{0} {τ}_{1} ( {∅}_{i} , {θ}_{i} ) , … , exp ( j 2 π {f}_{0} {τ}_{L} ( {∅}_{i} , {θ}_{i} ) ]}^{T}$$

is the 1-dimensional complex steering vector associated with direction (Øᵢ, θᵢ), L is the number of antenna array elements, and τ₁(Øᵢ, θᵢ) is the time taken by a plane wave to arrive from the ith source to the ith antenna element from direction (Øᵢ, θᵢ). The value of τ₁(Øᵢ, θᵢ) may be calculated by:

$${τ}_{1} ( {∅}_{i} , {θ}_{i} ) = \frac{{r}_{l} \cdot v ( {∅}_{i} , {θ}_{i} )}{c}$$

where rᵢ is the position vector of the lth antenna element, v(Øᵢ, θᵢ) is the unity vector in the direction of (Øᵢ, θᵢ), c is the speed of wave propagation, and “⋅” denotes the inner product.

This null-steering beamformer may be used to cancel a plane wave arriving from a known direction, such as to produce a null in the response pattern in the direction of the arrival of the plane wave. In an example, this null response pattern this is generated by estimating the signal arriving from a known direction, where the estimation is based on steering a conventional beam in the direction of the source and then subtracting the output from each element. An estimate of the signal may be made by delay-and-sum beam, such as using shift registers to provide the required delay at each element such that the signal arriving from the beam-steering direction appears in-phase after the delay. These waveforms may then be summed with equal weighting. This summed signal may then be subtracted from each element after the delay. This process is effective in reducing or eliminating strong interference, and may be repeated for cancellation of multiple incoming interference signals.

Referring back to FIG. 5, the input received from the detection subsystem 520 may be provided to a wideband spectrum sensing subsystem 580. When a malicious control or interference signal is detected, wideband spectrum sensing subsystem 580 may be used to characterize nearby frequency band (e.g., free channels). These characterized frequency bands may be used by the frequency hopping subsystem 585 to identify one or more free channels, select a free channel, and switch to that free channel.

In an example, the wideband spectrum sensing subsystem 580 and frequency hopping subsystem 585 may provide improved selection and switching to a free channel using compressive sensing based on Bayesian recovery and auto-correlation detection techniques. These techniques include the receiver sampling the wideband spectrum at few instances of time, which is used to recover samples of a wideband signal. The recovered signal undergoes autocorrelation detection to reveal the free channels. Assuming the wideband channel contains N sub-bands, the received signal at the receiver can be written as:

$$y ( t ) = {\sum }_{n = 1}^{N} {x}_{n} ( t ) * {h}_{n} ( t ) - w ( t )$$

where xₙ(t) represents the signal of the nth channel, hₙ(t) represents the nth channel, and w(t) represents the AWGN. Assuming that at a time t only M«N sub-bands are occupied and the rest of N−M sub-bands contain zero signals, the received signal may be rewritten as:

$$y ( t ) = {\sum }_{S} {x}_{n} ( t ) * {h}_{n} ( t ) + w ( t )$$

where S denotes the set of active sub-bands. The frequency domain representation of the received signal, Y(f), can be written as:

$$Y ( f ) = {\sum }_{S} {D}_{h} * {X}_{n} ( f ) + W ( f )$$

where Dₕ is an N×N diagonal channel gain matrix. To determine measurements based on these received signals, the frequency domain received signal may be multiplied with a measurement matrix as follows:

Z(f)=ΨY(f)

where Ψ is an M×N sampling matrix and Z(f) is an M×1 measurement vector. The wideband signal may then be reconstructed from Z(f) using Bayesian inference method. The reconstructed signal may be provided to an auto-correlation detection algorithm to identify the free channels out of the N sub-bands [x].

The input received from the detection subsystem 520 may also be provided to a message dropping subsystem 590. As described above, jamming and modification attacks may increase the number of received erroneous bits, which may increase the number of dropped packets. Separately, the message dropping subsystem 590 may use the input signal 510 and determination of extracted signal feature classification to instruct the autonomous vehicle to drop the malicious control messages.

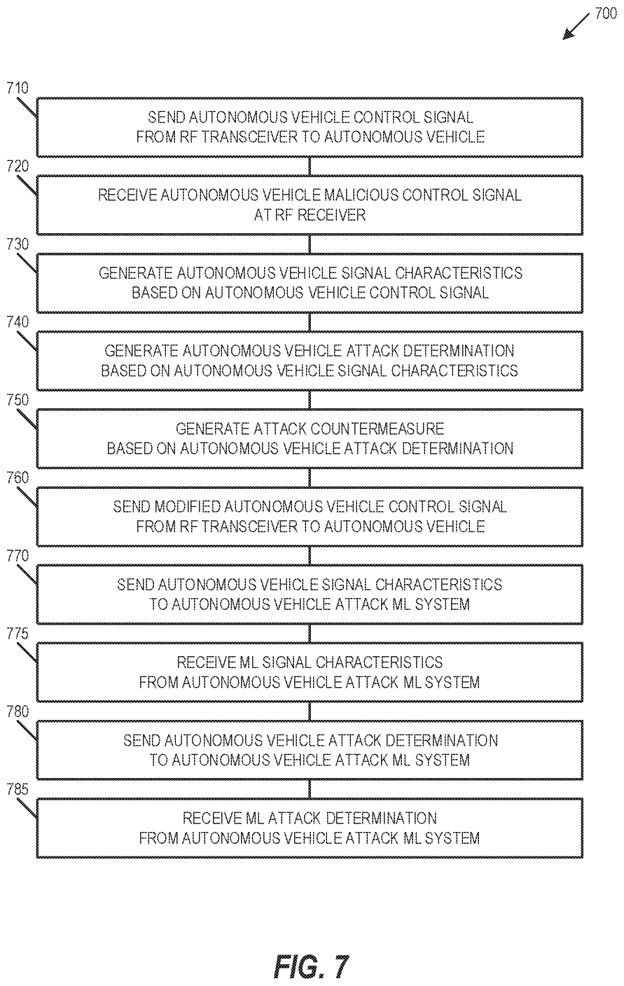

FIG. 7 is a diagram of an autonomous vehicle control attack defense method 700, in accordance with at least one embodiment. Method 700 includes sending 710 an autonomous vehicle control signal from a radio frequency (RF) transceiver to an autonomous vehicle. Method 700 includes receiving 720 an autonomous vehicle malicious control signal at an RF receiver. Method 700 includes generating 730 a plurality of autonomous vehicle signal characteristics based on the autonomous vehicle malicious control signal. Method 700 includes generating 740 an autonomous vehicle attack determination based on the plurality of autonomous vehicle signal characteristics. Method 700 includes generating 750 an attack countermeasure based on the autonomous vehicle attack determination. Method 700 includes sending 760 a modified autonomous vehicle control signal from the RF transceiver to the autonomous vehicle, the modified autonomous vehicle control signal generated based on the attack countermeasure.

Method 700 may include sending 770 the plurality of autonomous vehicle signal characteristics to an autonomous vehicle attack machine learning (ML) system. The autonomous vehicle attack ML system may include an autonomous vehicle attack ML model trained based on previously received autonomous vehicle attack signals. Method 700 may include receiving 775 a plurality of ML signal characteristics from the autonomous vehicle attack ML system. The generation of the attack determination may be further based on the plurality of ML signal characteristics.

Method 700 may include sending 780 the autonomous vehicle attack determination to the autonomous vehicle attack ML system and receiving 785 a ML attack determination from the autonomous vehicle attack ML system. The generation of the attack countermeasure may be further based on the ML attack determination.

The generation of the attack countermeasure may be based on a direction of arrival calculation. When the attack countermeasure is based on the direction of arrival calculation, the modification of the autonomous vehicle control signal may include causing the RF transceiver to modify the autonomous vehicle control signal based on at least one of null steering or beamforming. The generation of the attack countermeasure may be based on a wideband spectrum sensing. When the generation of the attack countermeasure is based on the wideband spectrum sensing, the modification of the autonomous vehicle control signal may include causing the RF transceiver to modify the autonomous vehicle control signal based on frequency hopping. The modification of the autonomous vehicle control signal may further include causing the RF transceiver to modify the autonomous vehicle control signal based on message dropping.

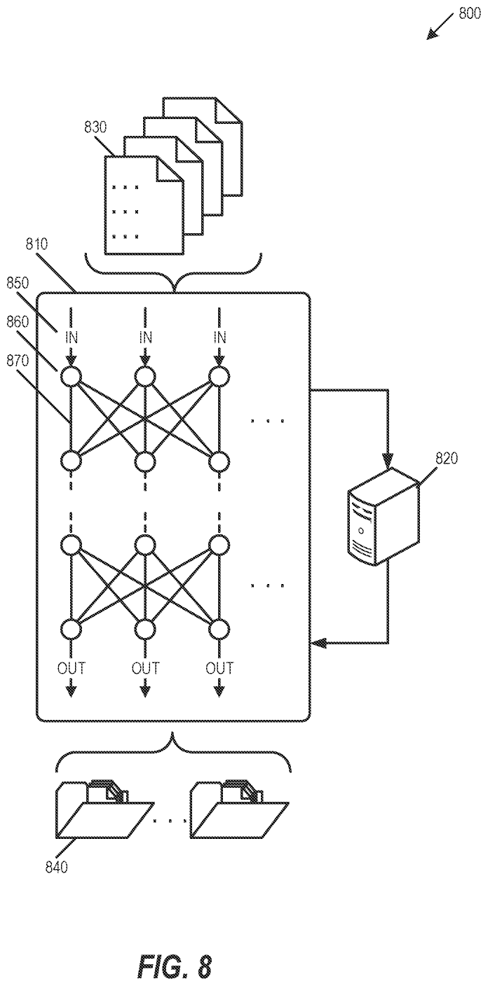

FIG. 8 is a block diagram of an example neural network training system 800 for autonomous vehicle control attack detection, according to an embodiment. The autonomous vehicle control attack classification may include an artificial intelligence (AI) analysis of autonomous vehicle control attack data characteristics. As used herein, AI analysis is a field concerned with developing decision-making systems to perform cognitive tasks that have traditionally required a living actor, such as a person. The AI analysis of autonomous vehicle control attack detection may be performed by an artificial neural network (ANN) algorithm using specific autonomous vehicle control attack classifiers described herein. An ANN includes a computational structure that may be loosely modeled on biological neurons. Generally, ANNs encode information (e.g., data or decision making) via weighted connections (e.g., synapses) between nodes (e.g., neurons). Modem ANNs are foundational to many AI applications, such as automated perception (e.g., computer vision, speech recognition, contextual awareness, etc.), automated cognition (e.g., decision-making, logistics, routing, supply chain optimization, etc.), automated control (e.g., autonomous cars, drones, robots, etc.), among others.

Many ANNs are represented as matrices of weights that correspond to the modeled connections. ANNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the ANN graph if the threshold is not exceeded then, the value is usually not transmitted to a down-graph neuron and the synaptic connection remains inactive. The process of weighting and testing continues until an output neuron is reached; the pattern and values of the output neurons constituting the result of the ANN processing.

The correct operation of most ANNs relies on correct weights. However, ANN designers may not know which weights will work for a given application. ANN designers typically choose a number of neuron layers or specific connections between layers including circular connection, but the ANN designer does may not know which weights will work for a given application. Instead, a training process is used to arrive at appropriate weights. However, determining correct synapse weights is common to most ANNs. The training process proceeds by selecting initial weights, which may be randomly selected. Training data is fed into the ANN and results are compared to an objective function that provides an indication of error. The error indication is a measure of how wrong the ANN's result was compared to an expected result. This error is then used to correct the weights. Over many iterations, the weights will collectively converge to encode the operational data into the ANN. This process may be called an optimization of the objective function (e.g., a cost or loss function), whereby the cost or loss is minimized.

Backpropagation is a technique whereby training data is fed forward through the ANN, where “forward” means that the data starts at the input neurons and follows the directed graph of neuron connections until the output neurons are reached, and the objective function is applied backwards through the ANN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of ANNs.

The autonomous vehicle control attack detection and mitigation system 800 may include an ANN 810 that is trained using a processing node 820. The processing node 820 may be a CPU, GPU, field programmable gate array (FPGA), digital signal processor (DSP), application specific integrated circuit (ASIC), or other processing circuitry. In an example, multiple processing nodes may be employed to train different layers of the ANN 810, or even different nodes 860 within layers. Thus, a set of processing nodes 820 is arranged to perform the training of the ANN 810.

The set of processing nodes 820 is arranged to receive a training set 830 for the ANN 810. The training set 830 may include previously stored data from one or more autonomous vehicle signal receivers. The ANN 810 comprises a set of nodes 860 arranged in layers (illustrated as rows of nodes 860) and a set of inter-node weights 870 (e.g., parameters) between nodes in the set of nodes. In various embodiments, an ANN 810 may use as few as two layers of nodes, or the ANN 810 may use as many as ten or more layers of nodes. The number of nodes 860 or number of node layers may be selected based on the type and complexity of the autonomous vehicle attack detection system. In various examples, the ANN 810 includes a node layer corresponding to multiple sensor types, a node layer corresponding to multiple perimeters of interest, and a node layer corresponding to compliance with requirements under 14 C.F.R. 107. In an example, the training set 830 is a subset of a complete training set of data from one or more autonomous vehicle signal receivers. Here, the subset may enable processing nodes with limited storage resources to participate in training the ANN 810.

The training data may include multiple numerical values that are representative of an autonomous vehicle control attack compliance classification 840, such as compliant, noncompliant unintentional, and noncompliant intentional. During training, each value of the training is provided to a corresponding node 860 in the first layer or input layer of ANN 810. Once ANN 810 is trained, each value of the input 850 to be classified is similarly provided to a corresponding node 860 in the first layer or input layer of ANN 810. The values propagate through the layers and are changed by the objective function.

As noted above, the set of processing nodes is arranged to train the neural network to create a trained neural network. Once trained, the input autonomous vehicle signal data 850 will be assigned into categories such that data input into the ANN 810 will produce valid autonomous vehicle control attack classifications 840. Training may include supervised learning, where portions of the training data set are labeled using autonomous vehicle attack classifications 840. After an initial supervised learning is completed, the ANN 810 may undergo unsupervised learning, where the training data set is not labeled using autonomous vehicle attack classifications 840. For example, the ANN 810 may be trained initially by supervised learning using previously classified autonomous vehicle signal data, and subsequently trained by unsupervised learning using newly collected autonomous vehicle signal data. This unsupervised learning using newly collected autonomous vehicle signal data enables the system to adapt to various autonomous vehicle control attack detection types. This unsupervised learning also enables the system to adapt to changes in the autonomous vehicle control attack types.

The training performed by the set of processing nodes 860 is iterative. In an example, each iteration of the training the neural network is performed independently between layers of the ANN 810. Thus, two distinct layers may be processed in parallel by different members of the set of processing nodes. In an example, different layers of the ANN 810 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 860 (e.g., neurons) are trained independently. In an example, the nodes are trained on different hardware.

The number and types of autonomous vehicle control attack classifications 840 may be modified to add, remove, or modify autonomous vehicle control attack classifications 840. This may enable the ANN 810 to be updated via software, which may enable modification of the autonomous vehicle attack detection system without replacing the entire system. A software update of the autonomous vehicle attack classifications 840 may include initiating additional supervised learning based on a newly provided set of input data with associated autonomous vehicle control attack classifications 840. A software update of the autonomous vehicle control attack classifications 840 may include replacing the currently trained ANN 810 with a separate ANN 810 trained using a distinct set of input data or autonomous vehicle control attack classifications 840.

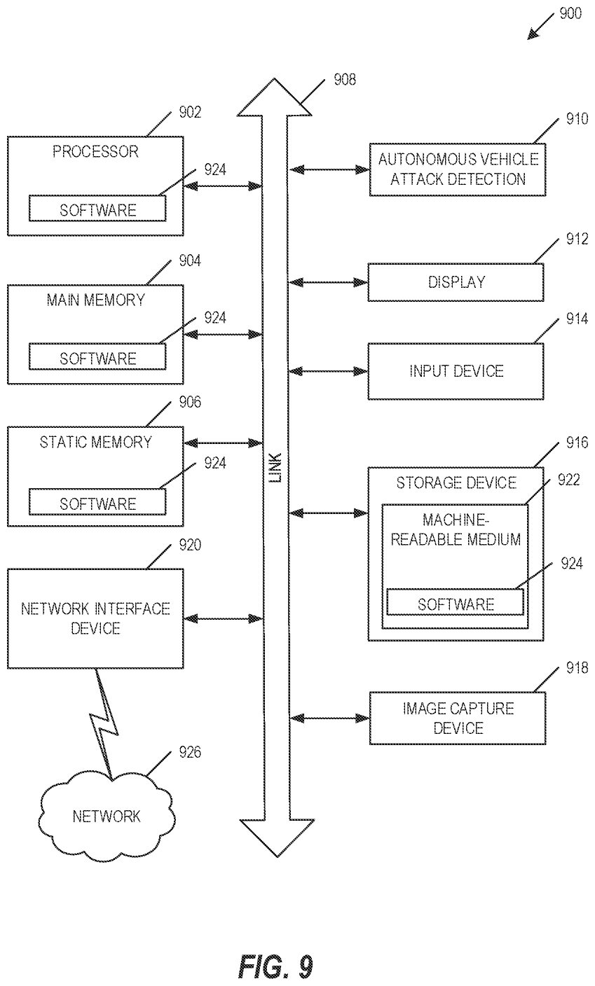

FIG. 9 is a block diagram illustrating an autonomous vehicle control attack detection and mitigation system in an example form of an electronic device 900, within which a set or sequence of instructions may be executed to cause the machine to perform any one of the methodologies discussed herein, according to an example embodiment. Electronic device 900 may represent a single device or a system of multiple devices combined to provide autonomous vehicle control attack detection and mitigation. In alternative embodiments, the electronic device 900 operates as a standalone device or may be connected (e.g., networked) to other machines. In a networked deployment, the electronic device 900 may operate in the capacity of either a. server or a client machine in server-client network environments, or it may act as a peer machine in peer-to-peer (or distributed) network environments. The electronic device 900 may be implemented on a System-on-a-Chip (SoC), a System-in-a-Package (SiP), an integrated circuit (IC), a portable electronic device, a personal computer (PC), a tablet PC, a hybrid tablet, a personal digital assistant (PDA), a mobile telephone, a server computer, or any electronic device 900 capable of executing instructions (sequential or otherwise) that specify actions to be taken by that machine to detect a user input. Further, while only a single electronic device 900 is illustrated, the terms “machine” or “electronic device” shall also be taken to include any collection of machines or devices that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to execute instructions, individually or jointly, to perform any one or more of the methodologies discussed herein.

Example electronic device 900 includes at least one processor 902 (e.g., a central processing unit (CPU), a graphics processing unit (GPU) or both, processor cores, compute nodes, etc.), a main memory 904 and a static memory 906, which communicate with each other via a link 908 (e.g., bus). The main memory 904 or static memory 906 may be used to store navigation data (e.g., predetermined waypoints) or payload data (e.g., stored captured images).

The electronic device 900 may include one or more autonomous vehicle control attack detection components 910, which may provide various autonomous vehicle control attack detection data to perform the detection and mitigation processes described above. The autonomous vehicle control attack detection components 910 may include an autonomous vehicle signal RF signal receiver, an input device to read plaintext autonomous vehicle signal data, or other device to receive the autonomous vehicle signal data set. The autonomous vehicle control attack detection components 910 may include processing specific to autonomous vehicle control attack detection, such as a GPU dedicated to machine learning. In an embodiment, certain autonomous vehicle control attack detection processing may be performed by one or both of the processor 902 and the autonomous vehicle control attack detection components 910. Certain autonomous vehicle control attack detection processing may be performed only by the autonomous vehicle control attack detection components 910, such as machine learning training or evaluation performed on a GPU dedicated to machine learning.

The electronic device 900 may further include a display unit 912, where the display unit 912 may include a single component that provides a user-readable display and a protective layer, or another display type. The electronic device 900 may further include an input device 914, such as a pushbutton, a keyboard, or a user interface (UI) navigation device (e.g., a mouse or touch-sensitive input). The electronic device 900 may additionally include a storage device 916, such as a drive unit. The electronic device 900 may additionally include one or more image capture devices 918 to capture images with different fields of view as described above. The electronic device 900 may additionally include a network interface device 920, and one or more additional sensors (not shown).

The storage device 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904, static memory 906, or within the processor 902 during execution thereof by the electronic device 900. The main memory 904, static memory 906, and the processor 902 may also constitute machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions 924. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of well-known transfer protocols (e.g., HTTP). Examples of communication networks include a local area network (LAN), a wide area network (WAN), the Internet, mobile telephone networks, and wireless data networks (e.g., Wi-Fi, NFC, Bluetooth, Bluetooth LE, 3G, 5G LTE/LTE-A, WiMAX networks, etc.). The term “transmission medium” shall be taken to include any intangible medium that is capable of storing, encoding, or carrying instructions for execution by the machine, and includes digital or analog communications signals or other intangible medium to facilitate communication of such software.

To better illustrate the method and apparatuses disclosed herein, a non-limiting list of embodiments is provided here.

Example 1 is an autonomous vehicle control attack mitigation system, the system comprising: a radio frequency (RF) transceiver to send and receive RF signals; processing circuitry; and one or more storage devices comprising instructions, which when executed by the processing circuitry, configure the processing circuitry to: receive the autonomous vehicle malicious control signal from the RF receiver; generate a plurality of autonomous vehicle signal characteristics based on the autonomous vehicle malicious control signal; generate an autonomous vehicle attack determination based on the plurality of autonomous vehicle signal characteristics; generate an attack countermeasure based on the autonomous vehicle attack determination; and cause the RF transceiver to modify the autonomous vehicle control signal based on the attack countermeasure.

In Example 2, the subject matter of Example 1 includes, the instructions further configuring the processing circuitry to: send the plurality of autonomous vehicle signal characteristics to an autonomous vehicle attack machine learning (ML) system, the autonomous vehicle attack ML system including an autonomous vehicle attack ML model trained based on previously received autonomous vehicle attack signals; and receive a plurality of ML signal characteristics from the autonomous vehicle attack ML system; wherein the generation of the attack determination is further based on the plurality of ML signal characteristics.

In Example 3, the subject matter of Examples 1-2 includes, the instructions further configuring the processing circuitry to: send the autonomous vehicle attack determination to the autonomous vehicle attack ML system; and receive a ML attack determination from the autonomous vehicle attack ML system; wherein the generation of the attack countermeasure is further based on the ML attack determination.

In Example 4, the subject matter of Examples 1-3 includes, wherein the generation of the attack countermeasure is based on a direction of arrival calculation,

In Example 5, the subject matter of Example 4 includes, wherein the modification of the autonomous vehicle control signal includes causing the RF transceiver to modify the autonomous vehicle control signal based on at least one of null steering or beamforming.

In Example 6, the subject matter of Examples 1-5 includes, wherein the generation of the attack countermeasure is based on a wideband spectrum sensing.

In Example 7, the subject matter of Example 6 includes, wherein the modification of the autonomous vehicle control signal includes causing the RF transceiver to modify the autonomous vehicle control signal based on frequency hopping.

In Example 8, the subject matter of Examples 1-7 includes, wherein the modification of the autonomous vehicle control signal includes causing the RF transceiver to modify the autonomous vehicle control signal based on message dropping.

Example 9 is an autonomous vehicle control attack mitigation method, the method comprising: sending an autonomous vehicle control signal from a radio frequency (RF) transceiver to an autonomous vehicle; receiving an autonomous vehicle malicious control signal at an RF receiver; generating a plurality of autonomous vehicle signal characteristics based on the autonomous vehicle malicious control signal; generating an autonomous vehicle attack determination based on the plurality of autonomous vehicle signal characteristics; generating an attack countermeasure based on the autonomous vehicle attack determination; and sending a modified autonomous vehicle control signal from the RF transceiver to the autonomous vehicle, the modified autonomous vehicle control signal generated based on the attack countermeasure.

In Example 10, the subject matter of Example 9 includes, sending the plurality of autonomous vehicle signal characteristics to an autonomous vehicle attack machine learning (ML) system, the autonomous vehicle attack ML system including an autonomous vehicle attack ML model trained based on previously received autonomous vehicle attack signals; and receiving a plurality of ML signal characteristics from the autonomous vehicle attack ML system; wherein the generation of the attack determination is further based on the plurality of ML signal characteristics.

in Example 11, the subject matter of Examples 9-10 includes, sending the autonomous vehicle attack determination to the autonomous vehicle attack ML system; and receiving a ML attack determination from the autonomous vehicle attack ML system; wherein the generation of the attack countermeasure is further based on the ML attack determination.

In Example 12, the subject matter of Examples 9-11 includes, wherein the generation of the attack countermeasure is based on a direction of arrival calculation.

in Example 13, the subject matter of Example 12 includes, wherein the modification of the autonomous vehicle control signal includes causing the RF transceiver to modify the autonomous vehicle control signal based on at least one of null steering or beamforming.

In Example 14, the subject matter of Examples 9-13 includes, wherein the generation of the attack countermeasure is based on a wideband spectrum sensing.

in Example 15, the subject matter of Example 14 includes, wherein the modification of the autonomous vehicle control signal includes causing the RF transceiver to modify the autonomous vehicle control signal based on frequency hopping.

In Example 16, the subject matter of Examples 9-15 includes, wherein the modification of the autonomous vehicle control signal includes causing the RF transceiver to modify the autonomous vehicle control signal based on message dropping.

Example 17 is one or more machine-readable medium including instructions, which when executed by a computing system, cause the computing system to perform any of the methods of Examples 9-16.

Example 18 is an apparatus comprising means for performing any of the methods of Examples 9-16.

Example 19 is at least one non-transitory machine-readable storage medium, comprising a plurality of instructions that, responsive to being executed with processor circuitry of a computer-controlled device, cause the computer-controlled device to: send an autonomous vehicle control signal from a radio frequency (RF) transceiver to an autonomous vehicle; receive an autonomous vehicle malicious control signal at an RE receiver; generate a plurality of autonomous vehicle signal characteristics based on the autonomous vehicle malicious control signal; generate an autonomous vehicle attack determination based on the plurality of autonomous vehicle signal characteristics; generate an attack countermeasure based on the autonomous vehicle attack determination; and send a modified autonomous vehicle control signal from the RF transceiver to the autonomous vehicle, the modified autonomous vehicle control signal generated based on the attack countermeasure.

In Example 20, the subject matter of Example 19 includes, the instructions further causing the computer-controlled device to: send the plurality of autonomous vehicle signal characteristics to an autonomous vehicle attack machine learning (ML) system, the autonomous vehicle attack ML system including an autonomous vehicle attack ML model trained based on previously received autonomous vehicle attack signals; and receive a plurality of ML signal characteristics from the autonomous vehicle attack ML system; wherein the generation of the attack determination is further based on the plurality of ML signal characteristics.

in Example 21, the subject matter of Examples 19-20 includes, the instructions further causing the computer-controlled device to: send the autonomous vehicle attack determination to the autonomous vehicle attack ML system; and receive a ML attack determination from the autonomous vehicle attack ML system; wherein the generation of the attack countermeasure is further based on the ML attack determination.

In Example 22, the subject matter of Examples 19-21 includes, Wherein the generation of the attack countermeasure is based on a direction of arrival calculation.

In Example 23, the subject matter of Example 22 includes, wherein the modification of the autonomous vehicle control signal includes causing the RF transceiver to modify the autonomous vehicle control signal based on at least one of null steering or beamforming.

In Example 24, the subject matter of Examples 19-23 includes, wherein the generation of the attack countermeasure is based on a wideband spectrum sensing.

In Example 25, the subject matter of Example 24 includes, wherein the modification of the autonomous vehicle control signal includes causing the RF transceiver to modify the autonomous vehicle control signal based on frequency hopping.

In Example 26, the subject matter of Examples 19-25 includes, wherein the modification of the autonomous vehicle control signal includes causing the RF transceiver to modify the autonomous vehicle control signal based on message dropping,

Example 27 is at least one machine-readable medium including instructions that, when executed by processing circuitry, cause the processing circuitry to perform operations to implement of any of Examples 1-26.

Example 28 is an apparatus comprising means to implement of any of Examples 1-26.

Example 29 is a system to implement of any of Examples 1-26.

Example 30 is a method to implement of any of Examples 1-26.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope should be determined with reference to the appended claims, along with the full scope of equivalents to which such claims are entitled.

What is claimed is:

1. An autonomous vehicle control attack mitigation system, the system comprising:
a radio frequency (RF) transceiver to send and receive RF signals;
processing circuitry; and.
one or more storage devices comprising instructions, which when executed by the processing circuitry, configure the processing circuitry to:
receive the autonomous vehicle malicious control signal from the RF receiver;
generate a plurality of autonomous vehicle signal characteristics based on the autonomous vehicle malicious control signal;
generate an autonomous vehicle attack determination based on the plurality of autonomous vehicle signal characteristics;
generate an attack countermeasure based on the autonomous vehicle attack determination; and
cause the RF transceiver to modify the autonomous vehicle control signal based on the attack countermeasure.

2. The system of claim 1, the instructions further configuring the processing circuitry to:
send the plurality of autonomous vehicle signal characteristics to an autonomous vehicle attack machine learning (ML) system, the autonomous vehicle attack ML system including an autonomous vehicle attack ML model trained based on previously received autonomous vehicle attack signals; and
receive a plurality of ML signal characteristics from the autonomous vehicle attack ML system;
wherein the generation of the attack determination is further based on the plurality of ML signal characteristics.

3. The system of claim 1, the instructions further configuring the processing circuitry to:
send the autonomous vehicle attack determination to the autonomous vehicle attack ML system; and
receive a ML attack determination from the autonomous vehicle attack ML system;
wherein the generation of the attack countermeasure is further based on the ML attack determination.

4. The system of claim 1, wherein the generation of the attack countermeasure is based on a direction of arrival calculation.

5. The system of claim 4, wherein the modification of the autonomous vehicle control signal includes causing the RF transceiver to modify the autonomous vehicle control signal based on at least one of null steering or beamforming.

6. The system of claim 1, wherein the generation of the attack countermeasure is based on a wideband spectrum sensing.

7. The system of claim 6, wherein the modification of the autonomous vehicle control signal includes causing the RF transceiver to modify the autonomous vehicle control signal based on frequency hopping.

8. The system of claim 1, wherein the modification of the autonomous vehicle control signal includes causing the RF transceiver to modify the autonomous vehicle control signal based on message dropping.

9. An autonomous vehicle control attack mitigation method, the method comprising:
sending an autonomous vehicle control signal from a radio frequency (RF) transceiver to an autonomous vehicle;
receiving an autonomous vehicle malicious control signal at an RF receiver;
generating a plurality of autonomous vehicle signal characteristics based on the autonomous vehicle malicious control signal;
generating an autonomous vehicle attack determination based on the plurality of autonomous vehicle signal characteristics;
generating an attack countermeasure based on the autonomous vehicle attack determination; and
sending a modified autonomous vehicle control signal from the RF transceiver to the autonomous vehicle, the modified autonomous vehicle control signal generated based on the attack countermeasure.

10. The method of claim 9, further including:
sending the plurality of autonomous vehicle signal characteristics to an autonomous vehicle attack machine learning (ML) system, the autonomous vehicle attack ML system including an autonomous vehicle attack ML model trained based on previously received autonomous vehicle attack signals; and
receiving a plurality of ML signal characteristics from the autonomous vehicle attack ML system;
wherein the generation of the attack determination is further based on the plurality of ML signal characteristics.

11. The method of claim 9, further including:
sending the autonomous vehicle attack determination to the autonomous vehicle attack ML system; and
receiving a ML attack determination from the autonomous vehicle attack ML system;
wherein the generation of the attack countermeasure is further based on the ML attack determination.

12. The method of claim 9, wherein the generation of the attack countermeasure is based on a direction of arrival calculation.

13. The method of claim 12, wherein the modification of the autonomous vehicle control signal includes causing the RF transceiver to modify the autonomous vehicle control signal based on at least one of null steering or beamforming.

14. The method of claim 9, wherein the generation of the attack countermeasure is based on a wideband spectrum sensing,

15. The method of claim 14, wherein the modification of the autonomous vehicle control signal includes causing the RF transceiver to modify the autonomous vehicle control signal based on frequency hopping.

16. The method of claim 9, wherein the modification of the autonomous vehicle control signal includes causing the RF transceiver to modify the autonomous vehicle control signal based on message dropping.

17. At least one non-transitory machine-readable storage medium, comprising a plurality of instructions that, responsive to being executed with processor circuitry of a computer-controlled device, cause the computer-controlled device to:
send an autonomous vehicle control signal from a radio frequency (RF) transceiver to an autonomous vehicle;
receive an autonomous vehicle malicious control signal at an RF receiver;
generate a plurality of autonomous vehicle signal characteristics based on the autonomous vehicle malicious control signal;
generate an autonomous vehicle attack determination based on the plurality of autonomous vehicle signal characteristics;
generate an attack countermeasure based on the autonomous vehicle attack determination; and
send a modified autonomous vehicle control signal from the RF transceiver to the autonomous vehicle, the modified autonomous vehicle control signal generated based on the attack countermeasure.

18. The machine-readable storage medium of claim 17, the instructions further causing the computer-controlled device to:
send the plurality of autonomous vehicle signal characteristics to an autonomous vehicle attack machine learning (ML) system, the autonomous vehicle attack ML system including an autonomous vehicle attack ML model trained based on previously received autonomous vehicle attack signals; and
receive a plurality of ML signal characteristics from the autonomous vehicle attack ML system;
wherein the generation of the attack determination is further based on the plurality of ML signal characteristics.

19. The machine-readable storage medium of claim 17, the instructions further causing the computer-controlled device to:
send the autonomous vehicle attack determination to the autonomous vehicle attack ML system; and
receive a ML attack determination from the autonomous vehicle attack ML system;
wherein the generation of the attack countermeasure is further based on the ML attack determination.

20. The machine-readable storage medium of claim 17, wherein the generation of the attack countermeasure is based on a direction of arrival calculation.
